(19) United States
(12) Patent Application Publication
(10) Pub. No.: US 2024/0028847 A1
(43) Pub. Date: Jan. 25, 2024

(54) READING AN OPTICAL CODE

(71) Applicant: SICK AG, Waldkirch (DE)

(72) Inventors: Romain MÜLLER, Waldkirch (DE); Pascal SCHÜLER, Waldkirch (DE)

(21) Appl. No.: 18/225,617

(22) Filed: Jul. 24, 2023

(30) Foreign Application Priority Data
Jul. 25, 2022 (EP) 22186760.9

(51) Int. Cl. G06K 7/10; G06K 7/14

(52) U.S. Cl. CPC G06K 7/10712; G06K 7/1413

(57) ABSTRACT

A method of reading an optical code (20) is provided in which image data with the code (20) are recorded by an image sensor (24), a first processing unit (30) reads the image data from the image sensor (24) and generates metadata with respect to the image data and/or to the code (20) in the course of a pre-processing of the image data, and a second processing unit (32) reads the code (20) after the pre-processing by the first processing unit (30), The second processing unit (32) reads the code (20) solely from the metadata without making use of the image data.

The invention relates to a method of reading an optical code and to a corresponding code reader.

Code readers are known from supermarket checkouts, for automatic parcel identification, for sorting mail shipments, from baggage handling at airports, and from other logistics applications. In a code scanner, a reading beam is guided transversely over the code by means of a rotating mirror or by means of a polygon mirror wheel. A camera based code reader takes images of the objects having the codes located thereon by means of an image sensor and image evaluation software extracts the code information from these images.

In an important application group, the objects bearing the code are conveyed past the code reader. A scanning code reader here detects the respective codes successively led into its reading zone. Alternatively, in a camera based code reader, a line scan camera reads in the object images having the code information successively and linewise with the relative movement. As a rule, image data are recorded using a two-dimensional image sensor that overlap more or less depending on the recording rate and on the conveying speed. So that the objects can be arranged in any desired orientation on the conveyor, a plurality of code readers are often provided at a reading tunnel to record objects from a plurality of sides or from all sides. A scanning code reader also detects the remission and thus ultimately image lines that can be assembled to form an object image, even though an image sensor is preferred for this purpose. Code zones can be identified in such an object field and one-dimensional or two-dimensional codes can be read out.

The images to be processed are becoming larger and larger thanks to the continuing development in camera and image sensor technology. The huge amounts of data present challenges for the limited processing capacities and bandwidths for forwarding to and processing in a camera under real time conditions. In this respect, the use of heterogeneous processing architectures, i.e. a combination of a microprocessor (central processing unit, CPU) having, for example, an FPGA (field programmable gate array), a DSP (digital signal processor), a GPU (graphics processing unit), or also a so-called AI accelerator (neural processing unit, NPU, tensor processing unit TPU).

The combination with an FPGA that is responsible for the reading of the image data from the image sensor has particularly proven itself here. The FPGA is additionally connected to a memory of the microprocessor via a high speed interface (peripheral component interconnect, PCI, PCI express, PCIE, mobile industry processor interface, MIPI). The image data are thus transmitted into the memory by the FPGA via DMA (direct memory access). This process of reading and saving is called streaming. The decoder implemented by means of a microprocessor can then access the stored images and read the codes downstream. The streaming approach is not easily possible using other above-named additional modules of a heterogeneous architecture that would as a rule themselves already require a stored image while the FPGA can read and further process image data directly pixel-wise.

The image data can already be pre-processed, on the fly so-to-say, by the FPGA during the streaming and additional information or metadata for the microprocessor can be stored with the image data in this process. Typical pre-processing steps are binarization which converts the original color or gray scale image into a binary black and white and a segmentation by which regions of interest (ROIs) having code candidates are located. The microprocessor can then restrict its decoding attempt directly to the regions of interest and can utilize the pre-processing results of the FPGA in so doing. This decoding is, however, still runtime intensive since the microprocessor can only perform its steps sequentially and for this purpose again and again has to read specific image data corresponding to the region of interest from the memory by a relatively time intensive direct access.

EP 2 003 599 A1 describes an optoelectronic sensor and a method for the detection of codes in which a binarizer is already configured for a conversion of a color image or a gray scale image into a binary image during the reception and/or in real time in that a respective read section is binarized even while the further sections are read in. EP 2 555 160 B1 locates regions of interest or code candidates using a contrast measure that is determined in part regions or tiles of the read image in a pre-processing on an FPGA. In EP 3 916 633 A1, first layers of a neural network are already run through for segmentation during the reading on an FPGA. In this respect, the capability of the FPGA is respectively used to carry out a number of simple processing operations such as matrix multiplications in parallel in real time. Sequential, more complex processing operations such as those of a decoder for reading optical codes are reserved for the microprocessor that makes use of the provided image data and possible pre-processing results for this purpose. In all these examples of a work position in a heterogeneous architecture, the microprocessor subsequently still has to access the image data to decode, with the described disadvantages with respect to the runtime.

It is therefore the object of the invention to further improve the code reading in a heterogeneous architecture.

This object is satisfied by a method of reading an optical code and by an optoelectronic code reading device in accordance with the respective independent claim. It must be clarified as a precaution that it is an automatically running process that is in particular implemented on a computer and that runs, for example, in a code reader or on a processing device connected thereto such as a control device, a computer, an edge device, or a cloud. The optical code to be read is preferably a barcode. In in this connection, the term barcode should be understood as a 1D barcode; in the literature, 2D codes are sometimes also variationally called barcodes. Image data with the code are recorded by a linear or matrix-like image sensor. As explained in the introduction, this can take place in a recording or successively during a relative movement, with the brightness profiles of a code scanner also being able to be understood as an image line.

A first processing unit reads out the image data and thus carries out a pre-processing in which pre-processed image data and/or metadata are acquired. Metadata are pieces of information on the image data or on the code such as the position, size, or type of the code. A pre-processing is, for example, a binarization, a resolution adaptation, image preparation, or a segmentation. A second processing unit reads the code after the pre-processing by the first processing unit. The second processing unit therefore has access to at least some of the results of the first processing unit. The two processing units advantageously form a heterogeneous architecture in the sense explained in the introduction with a processing being built up on one another in the sense of a pipeline.

The invention starts from the basic idea that only the first processing unit works with the actual image data and the second processing unit no longer has to access the image data to read the codes. The second processing unit rather reads the code solely from the metadata. The image data or the pre-processed image data are preferably nevertheless stored for other purposes, in particular for the case that the code reading solely on the basis of metadata fails. For although the method in accordance with the invention only uses metadata for the actual decoding, it can be embedded in a process in which at least one further conventional decoding attempt using the image data follows after a failed reading attempt.

Alternatively to a code reading by the second processing unit, a complete implementation of the method only on the first processing unit would also be conceivable to achieve even shorter decoding times. The first processing unit would then itself finally read the code solely from the metadata. This would, however be a departure from a heterogeneous architecture that would be associated with a comprehensive development and cost effort. The invention therefore starts from two processing units and the final step of the code reading solely from the metadata is carried out by the second processing unit in accordance with the invention.

The invention has the advantage that the decoding process is above all accelerated for barcodes. Processing times for memory accesses of the second processing unit to the image data are dispensed with. The saved runtime can be used in a typical real time application for the decoding of more demanding different codes to increase the reading rate overall. Alternatively, in particular to the extent that only barcodes are to be read, the throughput speed can be increased. The generally heterogeneous architecture can be maintained; it is not necessary to transpose the total decoder engine into the first processing unit with a substantial development and adaptation effort.

The metadata are preferably edge positions of black and white transitions in the image data. The first processing unit thus recognizes edges and thus edge positions in the image data in its pre-processing. The transition between a dark and a light code element is understood as an edge, in particular between a bar and a gap of a barcode. Bars and gaps are here only actually black and white in a binarized image, otherwise no difference is made here in a simplified form between white and light gray shades or black and dark gray shades. The term black and white transition should include the reverse direction of a white and black transition. This direction is preferably also known from the metadata for every edge position, for example by a direction bit or flag per edge or only for one edge from which then the direction for all the other edges can be unambiguously deduced due to the alternating sequence of black and white.

The metadata preferably have edge positions at least initially for a horizontal direction and a vertical direction. Black and white transitions are accordingly initially found by the first processing unit both in the X direction and in the Y direction and corresponding edge positions are generated. A selection is, however, possibly made in a second step and then only edge positions for one of the two directions are retained and forwarded to the second processing unit with the metadata.

Edge positions are preferably counted in the horizontal direction and in the vertical direction and a preferred direction of the code is determined using the edge positions with the higher number. This takes up the just explained possibility of making a selection in a second step. A barcode is read transversely to its bars in the ideal case and cannot be read in a mirror image longitudinally with respect to its bars. How the line direction and the column direction of the image data are oriented with respect to the barcode is not fixed in a general code reading application. The preferred direction in which more black and white transitions are present comes closer to the ideal case so that the preferred direction is found by counting the edge positions. Only edge positions in the preferred direction are advantageously further processed and forwarded as metadata; edge positions in the other direction can be discarded. The preferred direction is preferably already determined in the first processing unit; however, it can also only take place later in the processing chain in the second processing unit.

The edge positions are preferably determined multiple times, namely once per line and/or column of the image data. Theoretically, a single line of a suitable orientation through a barcode is sufficient to read its content. However, this requires an almost ideal image recording along the line not necessarily given in practice. The image of a barcode contains a plurality of lines in the X direction and the Y direction with the lines and columns of the image data and this redundancy can be used to improve the reading rate. The edge positions are correspondingly determined by the first processing unit for a plurality of or for all of the lines and/or columns of the image data. A two-dimensional field of edge positions is thus in particular produced with one dimension for the number of the line or column and the other dimension for the edge positions within the line or column. Two such two-dimensional fields can be created to distinguish the X direction and the Y direction.

Respective representative edge positions for the horizontal and/or vertical directions are preferably determined from the multiple edge positions with respect to a plurality of lines and/or columns. At the end, the barcode should not be read multiple times from a large number of redundant lines or columns, but only once. The redundantly determined edge positions are compressed to only one respective representative edge position for this purpose in this embodiment. In the representation of the previous paragraph as a two-dimensional field, a dimension reduction is so-to-say carried out and the second dimension is eliminated in that mutually corresponding edge positions are combined in a respective representative edge position. This combination or dimension reduction preferably takes place in the second processing unit, with preparatory steps already being able to be implemented in the first processing unit.

The lines and/or columns are preferably displaced with respect to one another for the location of representative edge positions to align the respective edge positions with one another. If the optical code is not coincidentally aligned exactly in the line or column direction, but has rather been recorded at a slant, the lines or columns have a mutual offset. This offset accumulates over the lines or columns. With a perfect compensation of the offset, a situation has been reached that corresponds to a recording with an alignment in the X or Y direction. This is not achieved in practice, but is the objective. The displacement preferably takes place in the second processing unit.

The respective required displacement is preferably determined by a comparison of a respective line with two adjacent lines and/or a respective column with two adjacent columns. The ith line is therefore compared with the i−1 st line and the i−2nd line, for example. In this respect, an error dimension is determined that accumulates the differences between the distances of the edge positions over the comparison lines. The degree to which displacement should take place to minimize the error dimension can be deduced from the error dimension. The error amounts to a maximum of one pixel in the preferred direction between two adjacent lines since the slanted position is restricted to 45°; it would otherwise not be the preferred direction. The explanation on the lines can be transferred analogously to columns if that is the preferred direction. The determination of the required displacement can already be implemented as a processing step in the first processing unit alternatively in the second processing unit. The actual displacement also takes place, as mentioned, in a preparatory determination of displacements by the first processing unit, preferably in the second processing unit.

The representative edge positions are preferably determined or corrected by forming and evaluating a position histogram. The edge positions are collected over the lines or columns in the position histogram. Ideally, in particular after a previous alignment as explained in the last two paragraphs, only narrow peaks of a width of one at edge positions coinciding over the lines or columns should be produced. A still required correction can be determined from the differences. The position histogram, preferably with a preceding alignment of the lines or columns, is more precise than a simple mean value formation over the lines or columns that is alternatively conceivable per se. The position histogram is preferably formed and evaluated in the second processing unit.

The first processing unit preferably reads the image data in an image data stream. The reading and forwarding of image data as an image data stream, preferably in groups of adjacent pixels, is called streaming. The first processing unit in particular respectively reads an image line or a part thereof from the image sensor; the image is accordingly read in or streamed linewise by the image sensor and the processing takes place with a line orientation. For pre-processing relating to more than one image line, the first processing unit can have an image buffer in which a corresponding number of image lines are buffered in a rolling manner. In principle, streaming can also take place column-wise instead of linewise in the same manner. This is here only understood as a difference in the definition of the coordinates and not distinguished. In accordance with the invention, the image data themselves or pre-processed image data do not have to be forwarded or stored since decoding takes place solely on the basis of the metadata. The streaming then only relates to the pre-processing and acquisition of metadata by the first processing unit. The image data are preferably additionally streamed into a memory for different purposes.

Read image data are preferably already processed still while the first processing unit reads further image data. The first processing unit is thus configured for a pre-processing on the fly or as early as during the streaming. This pre-processing so-to-say takes place directly at the source and even before any other instance has obtained the possibility of access to the image data at all.

The first processing unit preferably divides the image data into tiles, that is part regions of a predefined size, with the processing of the image data taking place tile-wise and with edge positions of black and white transitions in the image data being assembled over tiles in the metadata. This division is an a priori division in tiles of a predefined position and geometry, independently of the image content, in particular in a fixed pattern of rectangles of equal size having n×m or even more preferably n×n pixels. The image is, for example, split into at least five, at least ten, or even more tiles per line or column. Only respectively small data packets thereby have to be processed. The edge positions are required for decoding over the borders of tiles and are therefore assembled accordingly, with corresponding multiples of the width or height of a tile being added to an edge position depending on the position of the tile within a chain of tiles.

The first processing unit preferably classifies the files as to whether a part of a code has been recorded and orders tiles to a region of interest (ROI) with a code. The criterion whether a tile contains a code fragment is a sufficient contrast, for example. The image areas to be processed can be considerably reduced with the aid of regions of interest since optical codes typically only make up a small portion of the recorded image. The remaining tiles can be discarded, at least with respect to code reading. A plurality of codes or code candidates and thus a plurality of regions interest can be present that are then preferably worked through individually, with a parallelization being possible. The tiles that contain a code fragment in accordance with the classification are each associated with a region of interest having a code candidate.

The first processing unit preferably has an FPGA (field programmable gate array). An FPGA is particularly suitable for streaming image data and for a real time processing of large data quantities using a large number of comparatively simple individual computing operations. The second processing unit preferably has a microprocessor. A microprocessor is a lot more flexible and is capable per se of more complex computing steps and this is of advantage for a downstream metadata processing. The FPGA and the microprocessor together form a particularly advantageous heterogeneous architecture; conceivable alternatives have been described in the introduction.

The codes are preferably attached to objects that are conveyed through a detection zone of the image sensor on a conveying device. This is a typical code reading application in a stationary installation of the code reader, or at least of the image detecting part thereof, at a conveying device or a conveyor belt. The time window for reading the codes on the objects that are located in a relative movement with respect to the code reader is limited by the conveying movement. A particularly fast decoding is a great advantage under such real time conditions. This applies even when only a certain part of simply detectable barcodes can be dealt with by the method in accordance with the invention since then more decoding time is available for more complicated code types, unfavorable recording perspectives, poorer image quality, smaller resolution or module sizes, and the like.

In a preferred further development, an optoelectronic code reading device is provided with an image sensor for generating image data and with a control and evaluation unit that has a first processing unit and a second processing unit and in which a method in accordance with the invention for reading an optical code is implemented. The image sensor is a line sensor or a matrix sensor of a camera based code reading depending on the embodiment. A barcode scanner is also conceivable whose light reception element records a respective intensity profile that can be treated as an image line in the course of a scan. The control and evaluation unit is preferably a part of the code reading device itself and is in particular accommodated in its housing. However, at least one at least partially external control and evaluation unit is also conceivable.

The invention will be explained in more detail in the following also with respect to further features and advantages by way of example with reference to embodiments and to the enclosed drawing. The Figures of the drawing show in:

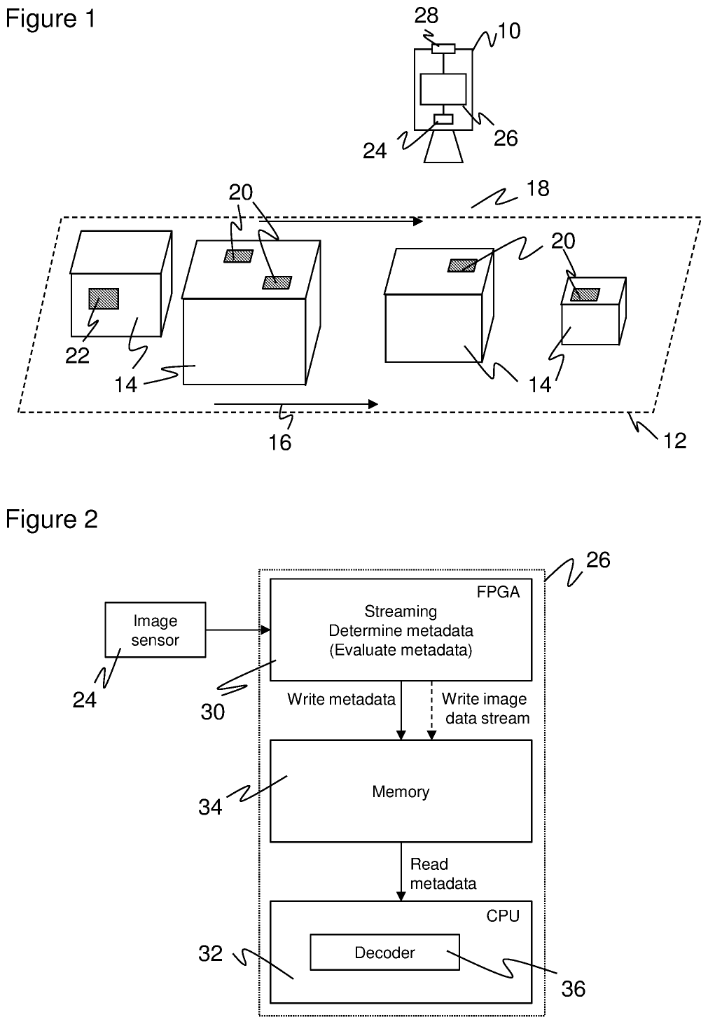

FIG. 1 a schematic overview representation of the exemplary installation of a camera based reading device above a conveyor belt;

FIG. 2 a schematic representation of a heterogeneous architecture for image evaluation and for code reading with an FPGA for streaming and pre-processing and a CPU for decoding;

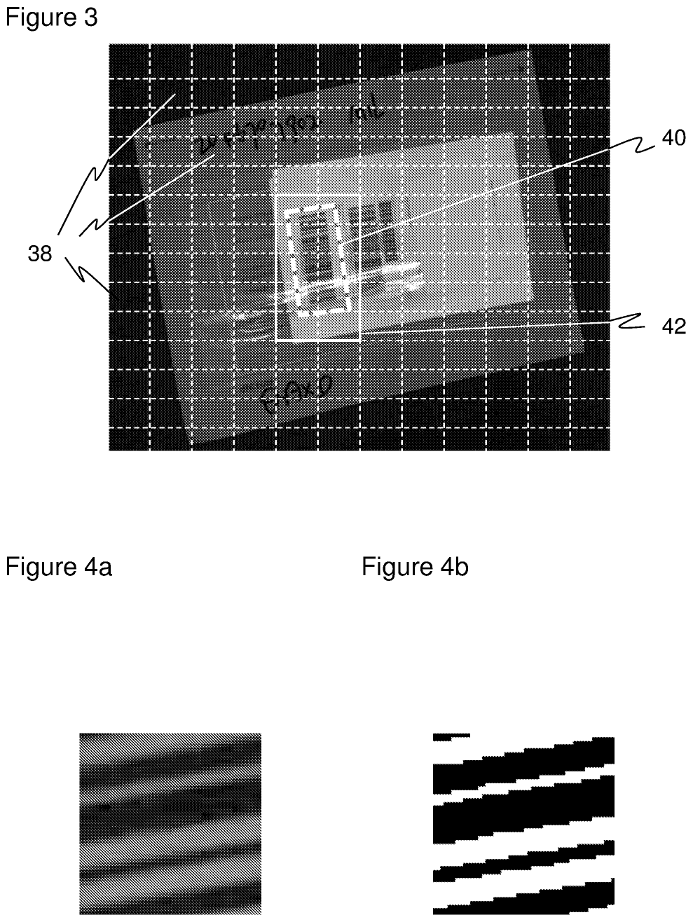

FIG. 3 an exemplary image with optical codes, a division into tiles, and a region of interest with an optical code;

FIG. 4a a representation of an exemplary tile with a code fragment;

FIG. 4b a representation of the binarized tile in accordance with FIG. 4a;

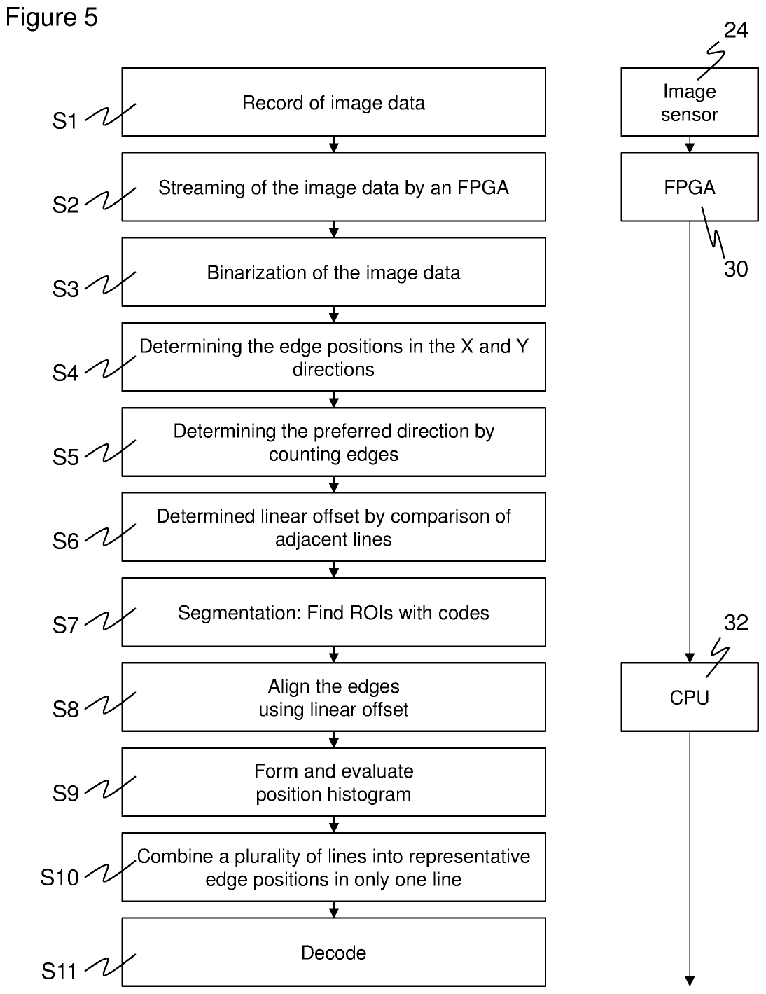

FIG. 5 an exemplary flowchart for generating metadata with edge positions by an FPGA and a subsequent reading of an optical code solely on the basis of the metadata by a microprocessor;

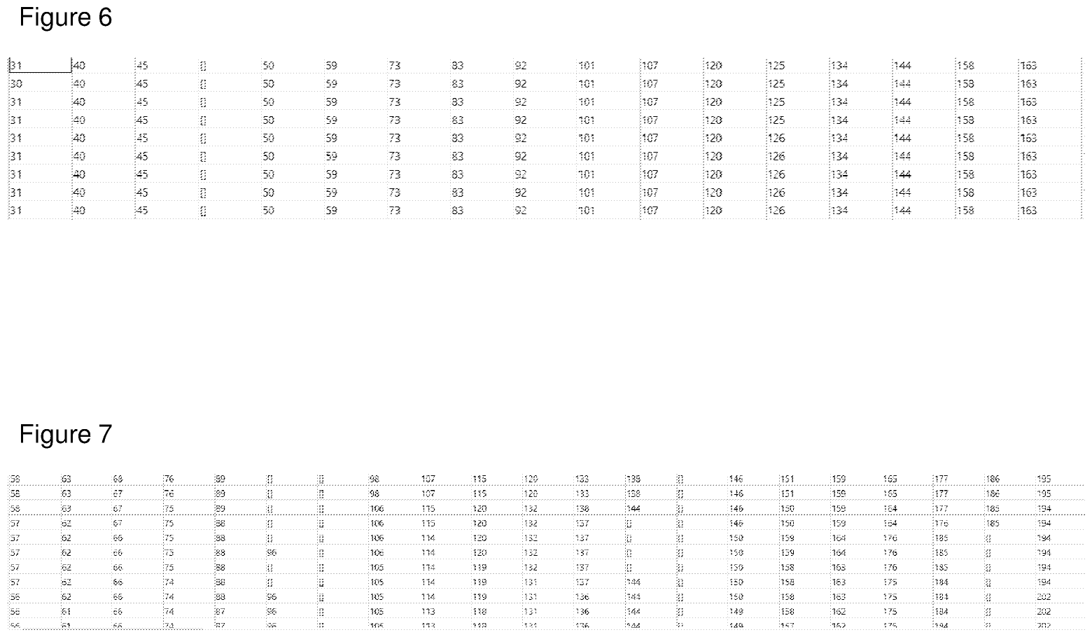

FIG. 6 a tabular representation of exemplary edge positions over a plurality of tiles on evaluation of a barcode aligned in the X or Y direction;

FIG. 7 a tabular representation similar to FIG. 6, but now with a barcode aligned neither in the X direction nor in the Y direction;

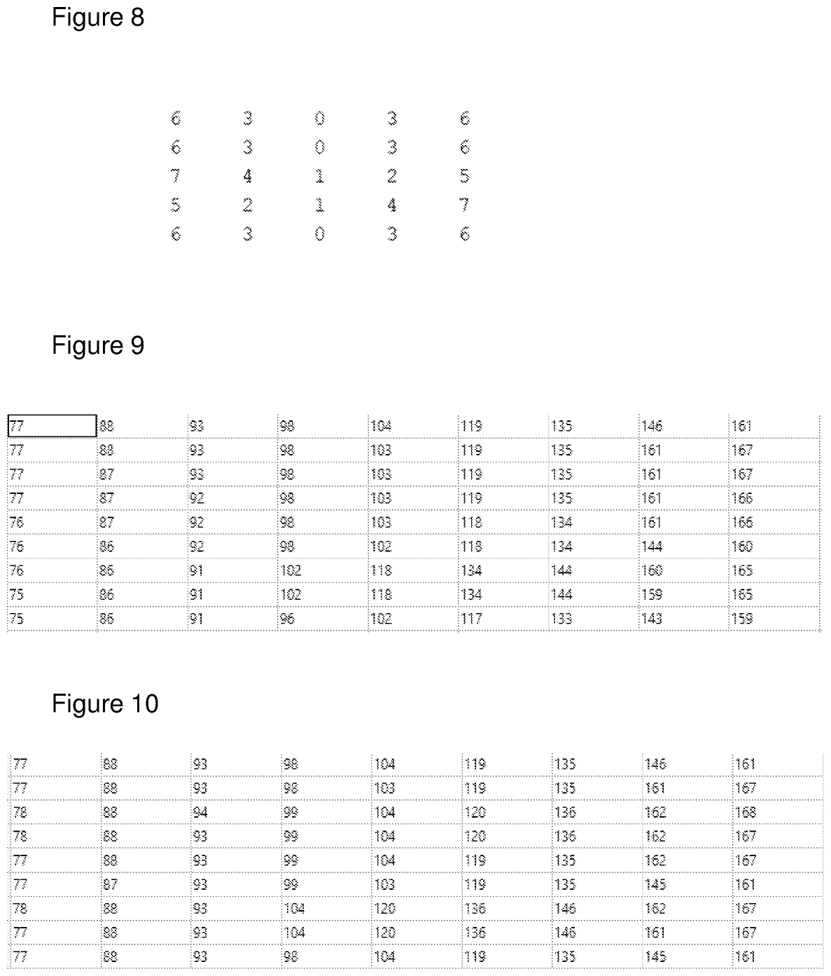

FIG. 8 a matrix-like representation of a displacement error between lines of the recording of a barcode;

FIG. 9 a further tabular representation of exemplary edge positions of a recorded barcode over a plurality of tiles;

FIG. 10 a tabular representation in accordance with FIG. 9 after correction of displacements between the lines;

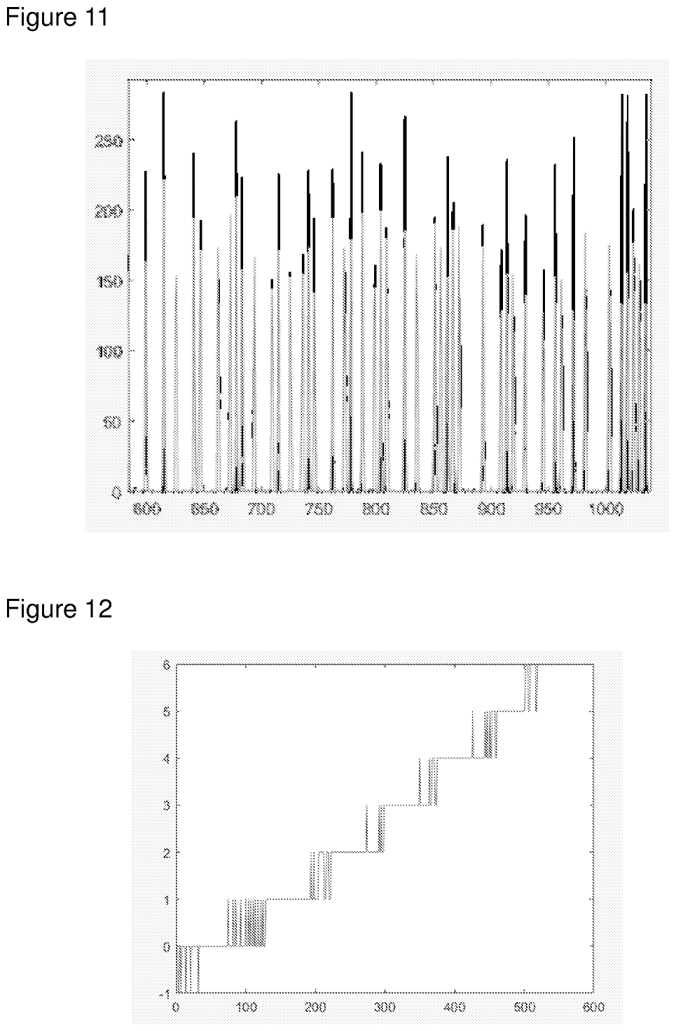

FIG. 11 an exemplary position histogram to explain an improved correction of displacements between the lines; and

FIG. 12 an illustration of the displacements detectable using the position histogram.

FIG. 1 shows a code reader 10 which is mounted above a conveyor belt 12 which conveys objects 14 through the detection zone 18 of the code reader 10, as indicated by the arrow 16. The objects 14 bear codes 20 on their outer surfaces which are detected and evaluated by the code reader 10. The codes 20 can only be recognized by the code reader 10 when they are affixed to the upper side or at least in a manner visible from above. Differing from the representation in FIG. 1, a plurality of code readers 10 can be installed from different directions for the reading of a code 22 affixed to the side or to the bottom, for instance, in order to permit a so-called omnireading from all directions. This stationary use of the code reader at a conveyor belt 12 is very common in practice. The invention, however, relates above all to the reading of codes 20 or to the code reader 10 itself so that this example may not be understood as restrictive.

The code reader 10 detects image data of the conveyed objects 14 and of the codes 20 by an image sensor 24 and said image data are further processed by a control and evaluation unit 26 by means of image evaluation and decoding processes. The control and evaluation unit 26 will be described in more detail immediately with reference to FIG. 2. The code reader 10 outputs information such as read codes or image data via an interface 28, possibly in different processing stages.

FIG. 2 shows the control and evaluation unit 26 and its integration in a schematic representation. The control and evaluation unit 26 in this preferred embodiment comprises a first processing unit 30 that will be explained in the following for the example of an FPGA (field programmable gate array) and a second processing unit 32 that will be explained in the following for the example of a microprocessor or a CPU (central processing unit).

The first processing unit 30 is, on the one hand, connected to the image sensor 24 and, on the other hand, has an interface in the direction of the second processing unit 32, preferably a high speed interface (PCI, PCIE, MIPI). Both processing units 30, 32 can access a memory 34 for image data and additional information, metadata, or processing results. The corresponding reading and writing procedures preferably take place by means of DMA (direct memory access). The memory 34 can be understood as preferably at least functional and, depending on the embodiment, also structurally as part of the second processing unit 32.

In operation, the image sensor 24 now respectively records a new image or a new image section. It can be a rectangular image of a matrix sensor, but individual or multiple image lines of a line sensor are also conceivable that then successively produce a total image in the course of the relative movement between the code reader 10 and the object 14. The image data of the image sensor 24 are read by the first control and evaluation unit 30. In this respect, metadata are preferably determined by pre-processing, and indeed advantageously on the fly, i.e. still while further image data of the image are to be read or are read by the image sensor 24. The pre-processing and the metadata thus acquired will be explained in more detail below with reference to FIG. 5. As represented by an arrow, the metadata are written to the memory 34. The image data themselves are not required for the code reading in accordance with the invention by the second processing unit 32, but are preferably likewise transferred or streamed directly and/or in a pre-processed manner into the memory 34, as shown by a dashed arrow.

The second processing unit 34 accesses the metadata in the memory 34 to further process them and to read the content of the recorded optical codes 20 solely from the metadata using a decoder 36 of the second processing unit 32. The decoder 36 works only with metadata for the method in accordance with the invention for reading codes and does not require any access to image data. This does not exclude the possible access to image data, in particular to read codes in at least one further reading attempt (retry) that could not be read solely from metadata. Since such uses of the image data are not part of the reading of codes in accordance with the invention, but are rather possible additions, only one arrow is shown for the reading of metadata and no arrow for a reading of image data.

The representation of FIG. 2 is to be understood as exemplary; only two processing units 30, 32 are generally required for the invention, with the first processing unit 30 reading image data and generating metadata by their pre-processing. The metadata are forwarded in any desired manner to the second processing unit 32 that reads codes solely from the metadata.

FIG. 3 shows an exemplary image with optical codes such as is recorded by the code reader 10. The image is preferably divided into tiles 38, preferably as shown in a uniform pattern of n×m pixels, with n and m being predefined such that a plurality of tiles are produced per line and column. Metadata are determined with respect to the tiles 38. It can, on the one hand, be evaluated from these metadata whether the respective tile 38 contains a structure of interest such as an optical code, for instance with respect to a degree of contrast and in particular to a variation in the grayscale distribution. The metadata above all serve, as still to be explained with respect to FIG. 5, the reading of codes. It has already been mentioned that the processing steps for acquiring the metadata on-the-fly are possible during the streaming.

It is not necessary to evaluate all the tiles 38. The image of FIG. 3 contains two optical codes, with one of the two codes being marked as a region of interest 40 by way of example. The other image is of no interest for the code reading. Only a selection 42 of tiles 38 that corresponds to the region of interest 40 is therefore preferably further processed. If there are a plurality of regions of interest, the selection 42 is correspondingly multiplied. It depends on the image whether there are one or more regions of interest 40 or possibly no region of interest 40 at all, for instance because the image does not contain any optical codes. The tile-wise processing of the image data is particularly advantageous, but not absolutely necessary. Even without tiles, the whole image does not necessarily have to be evaluated; other segmentations are known to locate regions of interest.

FIG. 4a shows for illustration an exemplary tile 38 from the selection 42 with a code fragment. A tile can have 24×24 or 48×48 pixels, for example. FIG. 4b shows the tile after a binarization, the conversion into a purely black and white image, an advantageous pre-processing step of the first processing unit 30.

FIG. 5 shows an exemplary flowchart for generating metadata with edge positions by an FPGA as an example of a first processing unit 30 and a subsequent reading of an optical code solely on the basis of the metadata by a microprocessor as an example of a second processing unit 32. The respective responsible units 24, 30, 32 for the individual steps of the flowchart are entered on the right side. This is a preferred association; at least some of the steps can selectively run on the first processing unit 30, on the second processing unit 32, or distributed over both processing units 30, 32. Some of the steps shown are furthermore optional; the invention is by no means restricted to the complete working through of all the steps shown in FIG. 5, even if this is a preferred embodiment.

The basic idea comprises locating edge positions in the image data using the first processing unit 30 and forwarding them as metadata to the second processing unit 32 that reads codes solely on the basis of the metadata without accessing the image data for this purpose. This is particularly suitable for barcodes having a sufficient module size of, for example, at least two ppm (pixels per module). Tiles 38, such as introduced in FIG. 3, are not necessarily required; FIG. 5 does not contain any reference to tiles 38. However, the individual steps are frequently explained with reference to tiles 38 because this is a preferred embodiment. The steps are often more complex due to the greater data volumes without tiles 38; conversely, no transitions between tiles 38 then have to be considered.

In a step S1, the image sensor 24 records an image with a certain gray scale depth or color depth of, for example, eight, ten, or twelve bits. In a second step S2, the image data are read out by the first processing unit 30 (streaming). The further steps for evaluating already read image data and for generating metadata can already be performed on the fly still while further image data are being read in. Tiles 38 are preferably formed for the further processing, as explained with reference to FIG. 3 and shown by way of example for a tile in FIG. 4a, and metadata are determined tile-wise. In this respect, it may be necessary to wait until sufficient image data have been buffered, for example a sufficiently large number of image lines corresponding to the height of a tile 38 have been read in.

In an optional step S3, the image data are binarized, that is converted into a two-value black and white image. The result of the binarization is shown by way of example for the tile of FIG. 4a in FIG. 4b. Edge transitions are sharply defined in the binarized image, but an edge can also be localized in a gray scale image or a color image in principle. During the binarization, alternatively before or after it, a resolution increase can optionally take place, for example from 24×24 pixels to 48×48 pixels (interpolation, for example bilinearly or bicubically, upsampling). The resolution increase facilitates the dealing with small module sizes or expands the application area of the method in accordance with the invention to smaller module sizes.

In a step S4, edge positions are determined in the X direction and in the Y direction. For this purpose, the position at which a transition from black to white or vice versa takes place is respectively noted along the lines or columns of the image data. Relative to a tile, this produces a series of edge positions for an individual line or column such as (13, 27, 32, 41, 46). If a size of tiles 48×48 is assumed, two times 48 such rows of edge positions are produced, once for the lines and once for the columns. This is a double line with 24×48×N edge positions, with N being able to vary with the lines and columns. A margin problem may occur if an edge is disposed just between two tiles. An additional line and column can be provided for this purpose or alternatively a tile size of 49×49 pixels can be selected with a one pixel overlap.

The information relevant to the later decoding as to whether it is a transition from black to white or a transition from white to black is still missing in the edge positions. This information can be appended to every edge position or a second list in the size of the list of the edge positions can be made with the additional information. Alternatively, this information is only taken along for a single transition per line and column since the further edges are thus clearly defined. These are only examples; a number of other representations such as a sign or a higher value bit of the edge positions are likewise possible.

The edge positions can be transferred in this form as metadata to the second processing unit 32 to read the code solely from the metadata without making use of the image data. However, optional additional preparations are preferably still performed by the first processing unit, as now described as steps S5 and S6, with only one of the steps, both steps, or neither of the steps being performed depending on the embodiment.

In a step S5, a preferred direction of the code in the image is determined. This step is optional or can alternatively only be performed later by the second processing unit 32. The code is recorded with any desired orientation and accordingly generally not in the X direction corresponding to the lines and not in the Y direction corresponding to the columns. Either the X direction or the Y direction is more suitable for the actual alignment of the code, however; this is the preferred direction. A decision can be made on this via the number of edges that are disposed in the X direction in comparison with the Y direction. A line transversely to a barcode crosses all its bars with a maximum number of edges; a line longitudinal to a barcode is at best incident on the edges at the upper and lower ends of the same bar. It becomes clear from this that the higher number of edges corresponds to the preferred direction. To determine the number, a respective counter is increased in the associated direction with each edge position for the X direction and the Y direction, for example. The double list with 2×48×N entries can now be further thinned out for the forwarding in the form of metadata to form a simple list with 1×48×N entries only for the preferred direction; the edge positions of the other direction can be discarded.

In an optional step S6, a linear offset is determined by a comparison of adjacent lines. The term line here stands for a line or column depending on whether the X direction or the Y direction is looked at. Only one of the two directions is preferably left as the preferred direction due to step S5; this is now assumed. The determination of the linear offset is a preparatory step toward a mutual alignment and combination of the edge positions over a plurality of lines to form a representative line, as described below with reference to steps S8 and S10. The first processing unit 30 thus preferably prepares the combination in step S6 and the second processing unit 32 performs it in steps S8 and S10. Alternatively, all the steps can already be performed in the first processing unit 30 or only in the second processing unit 32.

Since a barcode has a certain extent, edge positions do not stand only for one line, but are rather provided redundantly for a plurality of adjacent lines. This redundancy can be utilized and eliminated relatively easily for the ideal case that the code is aligned in the X direction or in the Y direction. FIG. 6 shows an example of edge positions assembled over a plurality of tiles for a plurality of adjacent lines in this ideal case. The edge positions practically do not differ so that, for example, any line could be picked out as representative; alternatively, a mean value calculation or a majority decision could be used.

With a general orientation of the code, and therefore with any and an initially unknown orientation of the code, things become more complicated, as the example shown in FIG. 7 illustrates. The slanted orientation is not the only conceivable cause of inconsistencies; erroneous detections of edges in single lines can also be produced by contamination and other disruptions.

A method by which compensating displacements between the lines are located in an efficient processing manner compares a respective line with its two adjacent lines. The first and second lines are uploaded for a tile and successively displaced with respect to one another by [−k, . . . , 0, . . . k] pixels, where k is a small natural number; k=2 is selected by way of example here. The difference of the two lines is formed pixel-wise for every displacement and is summed via the amount of these differences to obtain an error value: error=sum(abs(line1−line2)). The third line is then uploaded and a corresponding error value is calculated for the comparison between the first line and the third line and between the second line and the third line. This is repeated for the further groups of three of lines, that is first the second to fourth lines up to the 48th-48th line of a tile. A total of 46×2×5 error values results. FIG. 8 shows an exemplary 5×1×5 section thereof.

The error values are now initially evaluated linewise. Th maximum displacement window for the comparison of directly adjacent lines amounts to ±pixels since the slanted position of the code in the preferred direction is upwardly bounded by 45°. Five error values are available, corresponding to the five displacements [−k, . . . 0, . . . k] at k=2 that are designated by value(1) . . . value(5).

The following are fixed as rules for the displacement error shift:

$$If value ( 3 ) = 0 , then shift = 0. \\ If value ( 4 ) = 0 , then shift = - 1. \\ If value ( 2 ) = 0 , then shift = + 1. \\ Otherwise shift = - ( \frac{- 2}{value ( 1 )} + \frac{- 1}{value ( 2 )} + \frac{+ 1}{value ( 4 )} + \frac{+ 2}{value ( 5 )} ) .$$

The first three rules take the maximum possible displacement error into account. The fourth rule otherwise approximates the displacement error in a manner that is simple to calculate corresponding to the deviation from a maximum displacement with a respective weighted contribution. To avoid resource intensive divisions in an FPGA, look up tables (LUTs) can instead be implemented that form an inverse (n>1/n) and do not have to take account of a large number of values since the error values do not become large. If more processing resources are available, on the implementation on the second processing 32 for example, a more complex calculation can take place instead of the rules, for example a parabolic approximation with sampling points around value(3).

If lines l, (i−1) that are not directly adjacent are compared, but rather next but one adjacent lines l, (i−2), the procedure is similar, but only some pre-factors change. It must be considered here that now the maximum displacement error can amount to two pixels. The rules here are:

$$If value ( 3 ) = 0 , then shift = 0. \\ If value ( 4 ) = 0 , then shift = - 1 / 2. \\ If value ( 2 ) = 0 , then shift = + 1 / 2. \\ If value ( 1 ) = 0 , then shift = + 1. \\ If value ( 5 ) = 0 , then shift = - 1. \\ Otherwise shift = - 0.5 ( \frac{- 2}{value ( 1 )} + \frac{- 1}{value ( 2 )} + \frac{+ 1}{value ( 4 )} + \frac{+ 2}{value ( 5 )} ) .$$

A respective linewise displacement error is determined with shift, once for the comparison of the lines i, (i−1) and once of the lines i, (i−2). This can now be accumulated over i=1 . . . 45 lines of error values. shiftTotal(i)=shiftTotal(i−1)+shift. In addition, the sum of the displacement errors can be determined as a quality feature and it can be assumed, for example, on an exceeding of a threshold value that no good displacement could be found. The displacement error shiftTotal and the quality feature can be determined for the case of the displacement of the line i with respect to the line (i−1) and with respect to the line (i−2) and can be forwarded as metadata.

In a step S7, a segmentation now takes place in which regions of interest with codes are found. This is described, for example, in EP 2 555 160 B1 named in the introduction and can alternatively use any other segmentation process known per se, including processes of machine learning, in particular neural networks. The code type is preferably also determined in the segmentation. The decoding in accordance with the invention preferably works with barcodes and even more preferably with those that have been recorded at a minimum resolution, that is have a certain module size of, for example, at least two pixels per module. In a preferred embodiment, a decoding in accordance with the invention is only attempted solely using the metadata when corresponding conditions have been satisfied. Otherwise, a conventional decoder can be used directly that, however, has to access the image data again. The use of a conventional decoder is also possible if the reading attempt solely with the metadata fails (retry).

The segmentation first takes place very late in the routine, which means that the previously described steps are performed for all the tiles with any desired image information irrespective of whether any relative code fragments are contained in the tile at all. The previous results can be used for this to decide which tiles belong to a region of interest. Alternatively, the segmentation can already take place in an earlier step.

After the segmentation, the second processing unit 32 takes over from a step S8 onward. The first processing unit 30 has determined metadata tile-wise, namely edge positions, optionally the preferred direction and shifts together with the quality feature and some should now only be consolidated over tiles.

It may occur that all the tiles for a region of interest are not uniform over the preferred direction. A global preferred direction can then be fixed, for example, via a majority decision. The majority should be unambiguous for if not even the preferred direction can be clearly determined, a simple code reading using metadata would probably anyway fail. The minority of the tiles with a differing preferred direction can therefore be discarded.

The edge positions are strung together over tiles in that a corresponding multiple of the tile extent is summed to an edge position depending on the position of the tile within the region of interest. FIG. 9 shows by way of example edge positions for a plurality of lines in the preferred direction after the stringing together, but still without a correction of displacements.

In the optional step S8, the lines are then aligned with one another while making use of the shifts transferred in the metadata and the quality features of step S6 or in that, alternatively, this step S6 is only now performed by the second processing unit 32. A mean value can be determined, for example, to consolidate the shifts calculated per tile over the tiles. Overshoots are preferably eliminated beforehand, with the respective quality feature contained in the metadata being able to provide an indication. The process can optionally be aborted and a conventional decoder can be started up if too many tiles having poor quality features are affected, i.e. if the code can no longer be covered by tiles in the preferred direction whose quality features are sufficiently high.

The consolidated shift called the meanShift is now respectively deduced from the jth line. Since it is a shift between adjacent lines, scaling takes place with the linear index j: pos=pos−meanShift*j. FIG. 10 shows a result for the example of FIG. 9.

In an optional step S9, a position histogram is formed and evaluated. As can be recognized in FIG. 10, the targeted ideal case with the same lines in the table is actually not yet achieved solely by the shifts. The process described with respect to steps S6 and S8 is optimized for an FPGA and the shift over unavoidable processing errors of every algorithm really applied is therefore not exactly determined.

FIG. 11 shows an exemplary position histogram that is based, however, on different figures than the table in accordance with FIG. 10 for better statistics.

The position histogram collects the number entered on the Y axis as to how often these edge positions have been determined in its bins entered on the X axis corresponding to possible edge positions.

It can be determined during the building of the histogram line by line by the edge positions similar to the table in FIG. 10 whether a count is already present in an adjacent bin and an offset with respect to the adjacent bin is then noted. A list of offsets such as (0,0,1,0,−1,0,1, . . . ) is then produced after every line. A mean value offsetMean can then in turn be determined from this that is taken into account and deduced or added for every new line. The global offset of the preceding line is furthermore taken into account so that the offset for every line changes as follows: offset=floor(offset)+round(offsetMean). This offset is corrected linewise and is preferably combined with the above-described shift. The offset compensates errors that are due to the shift not having been able to be exactly determined.

FIG. 11 in precise terms does not only show a position histogram but rather the overlap of the just described process (dark) and a comparison (light) in which the exact shift has been manually calculated. The additional offset that is determined in step S10 is moreover illustrated in FIG. 12 in which the line number is entered on the X axis and the offset is entered on the Y axis.

In a step S10, the edge positions redundantly determined over a plurality of lines are now combined. To return to the example of FIG. 10 again, the redundant two-dimensional table should be compressed to a one-dimensional line. Ideally, the lines are identical to one another, the optional steps S8 and/or S10 with a correction of the mutual displacement due to shifts and/or offsets contribute to better approaching this ideal case. In a manner similar to the ideal case in accordance with FIG. 4 it is thus now possible to pick out a line, to form a mean value, to make a majority decision, or to carry out a simple calculation to find representative edge positions.

In a final step S11, the acquired one-dimensional list of edge positions is used to read the code. The differences of adjacent edge positions correspond directly to the widths of the bars and gaps of the barcode so that a decoding is now easily possible.

1. A method of reading an optical code in which image data with the code are recorded by an image sensor, a first processing unit reads the image data from the image sensor and generates metadata with respect to the image data and/or to the code in the course of a pre-processing of the image data, and a second processing unit reads the code after the pre-processing by the first processing unit,
wherein the second processing unit reads the code solely from the metadata without making use of the image data.

2. The method in accordance with claim 1,
wherein the metadata comprise edge positions of black and white transitions in the image data.

3. The method in accordance with claim 2,
wherein the metadata comprise edge positions at least initially for a horizontal direction and a vertical direction.

4. The method in accordance with claim 2,
wherein edge positions are counted in the horizontal direction and in the vertical direction and a preferred direction of the code is determined using the edge positions with the higher number.

5. The method in accordance with claim 2,
wherein the edge positions are determined multiple times.

6. The method in accordance with claim 5, wherein the edge positions are determined multiple times once per line and/or column of the image data.

7. The method in accordance with claim 5,
wherein respective representative edge positions for the horizontal and/or vertical directions are determined from the multiple edge positions with respect to a plurality of lines and/or columns.

8. The method in accordance with claim 7,
wherein the lines and/or columns are displaced against one another for the location of representative edge positions to align the respective edge positions with one another.

9. The method in accordance with claim 8,
wherein the respective required displacement is determined by a comparison of a respective line with two adjacent lines and/or a respective column with two adjacent columns.

10. The method in accordance with claim 7,
wherein the representative edge positions are determined or corrected by forming and evaluating a position histogram.

11. The method in accordance with claim 1,
wherein the first processing unit reads the image data in an image data stream.

12. The method in accordance with claim 11,
wherein the first processing unit reads the image data in the image data stream and read image data are already pre-processed still while the first processing unit reads further image data.

13. The method in accordance with claim 1,
wherein the first processing unit divides the image data into tiles, that is part regions of a predefined size, with the processing of the image data taking place tile-wise and with edge positions of black and white transitions in the image data being assembled over tiles in the metadata.

14. The method in accordance with claim 13,
wherein the first processing unit classifies the tiles as to whether a part of a code is recorded therein and associates tiles with a region of interest having a code.

15. The method in accordance with claim 1,
wherein the first processing unit has an FPGA (field programmable gate array) and/or the second processing unit has a microprocessor.

16. The method in accordance with claim 1,
wherein the codes are attached to objects that are conveyed through a detection zone of the image sensor on a conveying device.

17. An optoelectronic code reading device having an image sensor for generating image data and having a control and evaluation unit that has a first processing unit and a second processing unit and in which a method for reading an optical code is implemented, in which method image data with the code are recorded by the image sensor, the first processing unit reads the image data from the image sensor and generates metadata with respect to the image data and/or to the code in the course of a pre-processing of the image data, and the second processing unit reads the code after the pre-processing by the first processing unit, wherein the second processing unit reads the code solely from the metadata without making use of the image data.
